(19) United States
(12) Patent Application Publication
(10) Pub. No.: US 2009/0239545 A1
(43) Pub. Date: Sep. 24, 2009

(54) METHOD FOR RANDOM ACCESS IN CELLULAR SYSTEM

(75) Inventors: Kyoung-Seok Lee, Daejon (KR); Jae-Heung Kim, Daejon (KR); Jung-Im Kim, Daejon (KR); Soo-Jung Jung, Daejon (KR); Young-Jo Ko, Daejon (KR); Il-Gyu Kim, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INTITU, Daejon (KR)

(21) Appl. No.: 12/299,377

(22) PCT Filed: May 3, 2007
(86) PCT No.: PCT/KR2007/002178

§ 371 Date: Nov. 3, 2008

(30) Foreign Application Priority Data
May 3, 2006 (KR) 10-2006-0040131

(51) Int. Cl. H04W 72/00

(52) U.S. Cl. 455/450

(57) ABSTRACT

Disclosed is a random access method for minimizing delay for call setup, managing a random access request conflict, and adaptively allocating uplink radio resources according to the reason of an asynchronous random access from a terminal in an initial random access procedure between a base station and a terminal in a cellular mobile communication system for a packet service. The method begins with a radio resource control (RRC) layer of the terminal transferring a control primitive and an RRC connection request message to a medium access control (MAC) layer of the terminal. The MAC layer of the terminal requests the MAC layer of the base station to allocate a resource for random access. The MAC layer of the base station allocates resources upon the allocation request from the terminal and transfers the resources to the MAC layer of the terminal. The MAC layer of the terminal sets up an uplink sub-channel based on the allocated resources and transfers the RRC connection request message to the MAC layer of the base station through the uplink sub-channel. The MAC layer of the base station analyzes the RRC connection request message and requests the RRC layer of the base station to set up the RRC connection. The MAC layer of the base station transfers an RRC connection setup message to the terminal.

### TECHNICAL FIELD

The present invention relates to a random access method in a cellular mobile communication system; and, more particularly, to a random access method for minimizing delay for call setup, managing a random access request conflict, and adaptively allocating uplink radio resources according to the reason of an asynchronous random access from a terminal in a random access procedure for initially accessing a base station or a terminal in a cellular mobile communication system for providing a packet service.

### BACKGROUND ART

In order to clearly describe the present invention, a wireless access protocol structure of a 3^{rd} generation mobile communication network will be described at first.

The wireless access protocol of the 3^{rd} generation mobile communication network includes a physical layer, a data link layer, and a network layer, horizontally. The wireless access protocol vertically includes a user plane for transmitting data information and a control plane for transmitting a control signal. Protocol layers can be divided into a first layer L1, a second layer L2, and a third layer L3 based on a lower three layers of an open system interconnection (OSI), which is widely known in a communication system.

The first layer is the physical layer that provides an information transfer service to upper layers using a physical channel. The physical layer is connected to a medium access control (MAC) layer through a transport channel. The transports channel enables data to move between the MAC layer and the physical layer.

The second layer is the MAC layer that provides services to an upper layer such as a radio link control (RLC) layer through a logical channel. The RLC layer supports reliable data transmission and performs functions for segmenting and concatenating an RLC service data unit (SDU) from the upper layer.

A radio resource control (RRC) layer, which is the lowest layer of the third layer, is defined only in a control plane. The RRC layer control a logical channel, a transport channel, and a physical channel related to configuration, re-configuration, and the release of radio bearers.

Hereinafter, an initial random access procedure in a conventional Wideband Code Division Multiple Access (WCDMA) mobile communication system will be described.

In the conventional WCDMA mobile communication system, the initial random access is performed through a physical channel and a transport channel for random access. The physical channel for random access is configured of an uplink preamble channel and a downlink acquisition indication channel (AICH).

A terminal for random access transmits a preamble to a base station by selecting one of access slots and one of signatures based on a contention based transmission scheme. The preamble is transmitted during an access slot having a predetermined length, and the terminal selects one of a plurality of signatures and transmits the selected signature during a predetermined length of an access slot.

A base station detects a preamble transmitted from a terminal and transmits a response indicator through an AICH, that is, a downlink physical channel, at a reserved time. The AICH transmits a signature selected by the preamble during a predetermined beginning time of an access slot corresponding to the access slot transmitting the preamble. Herein, the base station transmits a positive acknowledgement (ACK) or a negative acknowledgement (NACK) through the signature transmitted by the AICH.

A terminal that receives the positive acknowledgement (ACK) through the AICH transmits a random access message to a base station using a random access channel (RACH) that is a transport channel and a physical random access channel (PRACH) that is a physical channel. The base station checks the random access message transmitted from the terminal. Then, the terminal and the base station transmit and receive control information or data using a channel for data transmission.

When a terminal performs an initial access procedure, operations that relate to accessing a terminal or a base station are performed using an RRC establishment procedure. That is, the initial access procedure is a procedure for a terminal in an idle mode to transit to an RRC connection mode in a view of RRC protocol. The RRC connection procedure of a terminal is performed using two types of control information. That is, the RRC connection procedure of a terminal includes an operation for transmitting and receiving data by configuring a logical channel using a radio resource control (RRC) layer and an operation for transmitting and receiving control primitive from the RRC layer to the MAC layer.

The logical channel is a channel generally used for transmitting and receiving a protocol message between the RRC layers of a terminal and a base station, and the protocol message is transmitted using a transport channel and a physical channel. However, the MAC layer or the physical layer does not modulate or change messages and performs only operations related to transmitting data. A logical channel used in an initial access procedure is a common control channel (CCCH). A terminal forms an RRC connection request message with the CCCH and transmits the formed RRC connection request message to a base station. A base station that successfully receives the RRC connection request message forms an RRC connection setup message with the CCCH and transmits the RRC connection setup message to a terminal. Then, the terminal forms an RRC connection setup complete message after this operation ends and transmits the RRC connection setup complete message to the base station, thereby informing of the successful RRC connection.

A terminal sets up an environment for controlling a transport channel and a physical channel by transmitting a control primitive to a MAC layer as well as the logical channel transmission operation. That is, an RRC layer of a terminal requests a MAC layer to perform a random access procedure using a CMAC-CONFIG-Req primitive in an initial access procedure.

Accordingly, the initial access procedure of a terminal ends after performing a procedure for forming a CCCH message and transmitting the CCCH message from an RRC layer and a procedure for forming a control primitive with a MAC layer and transmitting the control primitive.

The major function in the RRC connection procedure of a terminal is to allocate a terminal identifier (ID). When a terminal operates with a Temporary Mobile Station Identifier (TMSI) and or an International Mobile Subscriber Identifier (IMSI) stored temporally, a base station must be allocated with a Cell-Radio Network Temporary Identifier (C-RNTI) and a UTRAN-Radio Network Temporary Identifier (U-RNTI) to identify a terminal in order to enable the terminal to access the base station and transmit data to the base station. These identifiers IDs are information needed for a base station to manage the locations of terminals and to address. When the RRC connection is sustained, a base station and a terminal sustain the ID information.

In the initial access procedure, the identifier ID is allocated through an RRC connection establishment procedure. That is, when a terminal transmits an RRC connection request message to a base station, an RRC layer of the base station receives the RRC connection request message. Then, the base station allocates a C-RNTI, a terminal identifier, and transmits an RRC connection setup message with the C-RNTI. After the terminal receives the RRC connection setup message, the RRC layer of the terminal analyzes the received message, identifies the allocated C-RNTI, and informs a MAC layer of the identifying result.

Meanwhile, a long term evolution (LTE) system was introduced for providing various packet services and the related standardization processes have been in progress, recently. The LTE system is a packet based system for providing a pure packet service. In order to effectively and variably use radio resources in the LTE system, there is a demand for developing a method for simplifying an asynchronous random access procedure, minimizing delay for call setup, and performing an asynchronous random access procedure with minimum radio resources used.

### DISCLOSURE

### Technical Problem

An embodiment of the present invention is directed to providing a method for processing random access in a terminal, which can minimize time delay for an asynchronous random access performed by a terminal to access a base station in a cellular mobile communication system for providing packet services.

Another embodiment of the present invention is directed to providing a method for processing random access in a base station, which can adaptively allocate uplink radio resource according to the reason of an asynchronous random access from a terminal.

Still another embodiment of the present invention is directed a method for processing random access in a terminal, which can minimize time delay for call setup in an asynchronous random access performed by a terminal to access a base station and manage random access conflict in a cellular mobile communication system for providing packet services.

Further another embodiment of the present invention is directed to providing a method for processing random access in a terminal that allocates uplink radio resources according to a synchronous random access request of a terminal in an active state.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for processing random access to a base station in a terminal for random access between a terminal and a base station, which includes the steps of: a) at an radio resource control (RRC) layer of the terminal, transferring a control primitive and an RRC connection request message to a medium access control (MAC) layer of the terminal; b) at the MAC layer of the terminal, requesting the base station to allocate a resource for random access through a physical layer of the terminal; c) at the MAC layer of the terminal, setting up an uplink sub-channel using the resource information allocated by the base station; d) at the MAC layer of the terminal, transferring the RRC connection request message to the MAC layer of the base station through the uplink sub-channel; and e) at the MAC layer of the terminal, receiving an RRC connection setup message from the MAC layer of the base station and transferring the RRC connection setup message to the RRC layer of the terminal.

In accordance with another aspect of the present invention, there is provided a method for processing random access in a base station for random access between a terminal and a base station, which includes the steps of: a) at a physical layer of the base station, transferring a random access order primitive to a MAC layer of the base station upon receipt of a random access request transmitted from the terminal through a random access channel; b) at the MAC layer of the base station, allocating resources according to the random access order primitive; c) at the MAC layer of the base station, transferring a response primitive including the allocated resource information and a scheduling identifier (MAC ID) of the base station to a physical layer of the base station; d) at the MAC layer of the base station, transferring an RRC connection request to the RRC layer of the base station if the MAC layer of the base station receives an RRC connection request message from the terminal through an uplink sub-channel using the allocated resource; e) at the RRC layer of the base station, transferring an RRC connection setup message to a MAC layer of the base station according to the RRC connection request; and f) at the MAC layer of the base station, transferring the RRC connection setup message to the terminal through a downlink sub-channel.

In accordance with another aspect of the present invention, there is provided a method for processing asynchronized random access in a terminal for random access between a terminal and a base station, which includes the steps of: a) at an RRC layer of the terminal, transferring a control primitive and an RRC connection request message to a MAC layer of the terminal; b) at the MAC layer of the terminal, requesting the base station to allocate resources for random access through a physical layer of the terminal; c) retransmitting the resource allocation request without back-off if the physical layer of the terminal does not receive a response for the resource allocation request from the base station; d) at the MAC layer of the terminal, setting up an uplink sub-channel using information about resources allocated by the base station if the MAC layer of the terminal receive the information about the resource allocated by the base station through the physical layer of the terminal; e) at the MAC layer of the terminal, transferring the RRC connection request message to the MAC layer of the base station through the uplink sub-channel; and f) at the MAC layer of the terminal, receiving an RRC connection setup message from the MAC layer of the base station and transferring the RRC connection setup message to the RRC layer of the terminal.

In accordance with another aspect of the present invention, there is provided a method for processing synchronized random access in a terminal for random access between a terminal and a base station, which includes the steps of: a) at a terminal in an active state, transmitting an uplink radio allocation request to a base station; b) at the terminal, searching uplink scheduling information transmitted through a downlink for a predetermined time; c) at the terminal, retransmitting uplink radio allocation request for synchronized random access if the terminal does not receive the uplink scheduling information for the predetermined time; and d) at the terminal, transmitting packet data using a radio resource allocated by confirming uplink radio resources allocated by the base station if the terminal searches the uplink scheduling information within the predetermined time.

### ADVANTAGEOUS EFFECTS

A random access method according to an embodiment of the present invention can simplify an RRC control procedure of a terminal by unifying a procedure for forming and transmitting a CCCH message in an RRC procedure of a terminal and a procedure for forming a MAC control primitive in an asynchronous random access tried by a terminal to access a base station and by performing the unified procedure in a cellular system for providing a packet service.

In the random access method according to the embodiment of the present invention, a base station receiving an RA burst allocates a scheduling identifier (MAC ID), which is a terminal unique identifier, in a MAC layer, not an RRC layer. Accordingly, time delay can be reduced. Also, an RRC layer of a base station directly identifies a terminal ID of an RRC message, which is received at a base station through uplink sub-channel, and responses to terminal. Therefore, signaling operation to a gateway can be reduced.

Furthermore, in the random access method according to the embodiment of the present invention, a synchronous random access is performed based on a timer. Therefore, it can be properly operated according to whether a synchronous random access is successfully performed or not without additional control information.

### BRIEF DESCRIPTION OF THE DRAWINGS

FIG. 1 is a flowchart illustrating a method for processing initial asynchronous random access in accordance with an embodiment of the present invention.

FIG. 2 is a flowchart describing a method for processing asynchronous random access in a terminal in accordance with an embodiment of the present invention.

FIG. 3 is a flowchart illustrating a method for processing synchronous random access in a terminal in accordance with an embodiment of the present invention.

### BEST MODE FOR THE INVENTION

The advantages, features and aspects of the invention will become apparent from the following description of the embodiments with reference to the accompanying drawings, which is set forth hereinafter.

In the 3^{rd} generation partnership project (3GPP), discussions about a long term evolution (LTE) have been in progress. LTE is a technology for embodying high speed packet based communication, for example about 100 Mbps, and it is expected that the LTE will be commercialized in about a year of 2010. Recently, an orthogonal frequency division multiplexing access (OFDMA) is considered to be used in LTE. Unlike a code division multiple access (CDMA) discriminating radio resources for each terminal by allocating a code, an OFDMA system has 2-dimensional radio resource discriminated by a frequency and a time. That is, the OFDMA system divides radio resources configured of a time and a frequency and transmits it through a downlink physical channel and an uplink physical channel, and uses a radio resource block divided into a transmission time interval (TTI) and a sub carrier group as a radio resource. A radio frame is configured of millisecond slots or TTIs. For example, about 10 millisecond of radio frame includes 20 slots.

In the LTE system, random access is divided into an asynchronized random access and a synchronized random access by a use condition. The asynchronized random access is an initial random access for a terminal to access a base station when a terminal does not synchronize a physical layer with a base station or in an idle state. The synchronized random access is used for a terminal to request an uplink radio resource when a terminal is in an active state or a connected state for exchanging data with a base station with a uplink physical layer synchronized.

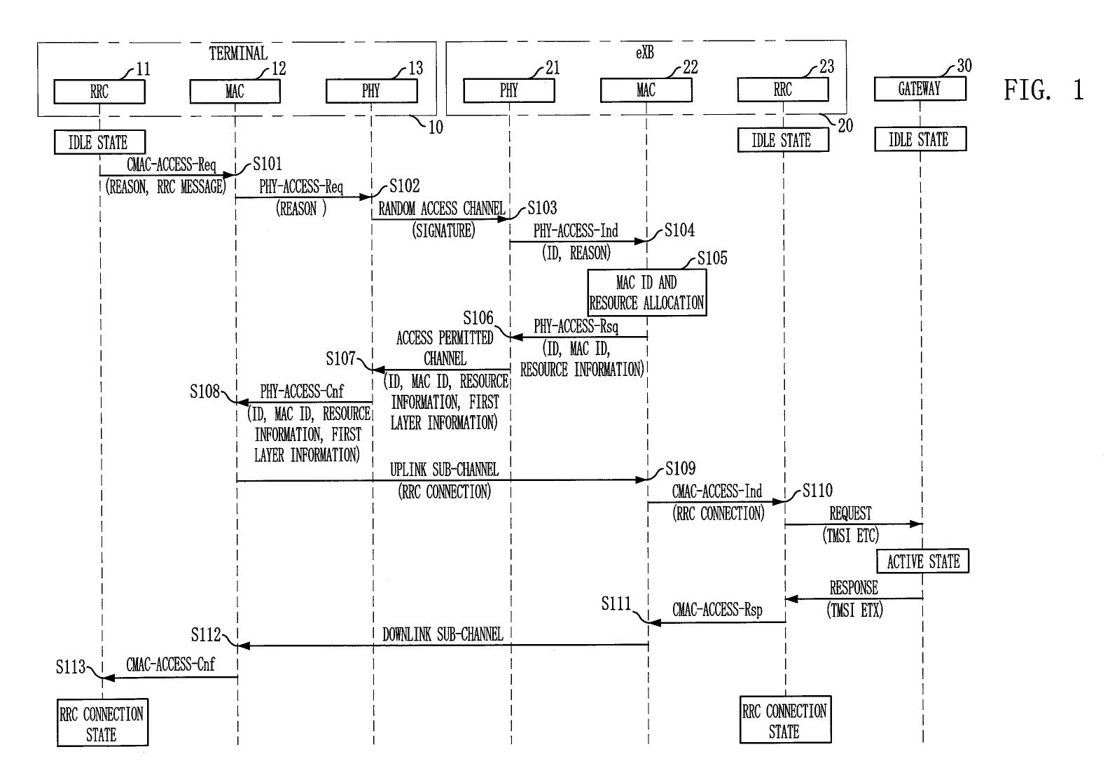

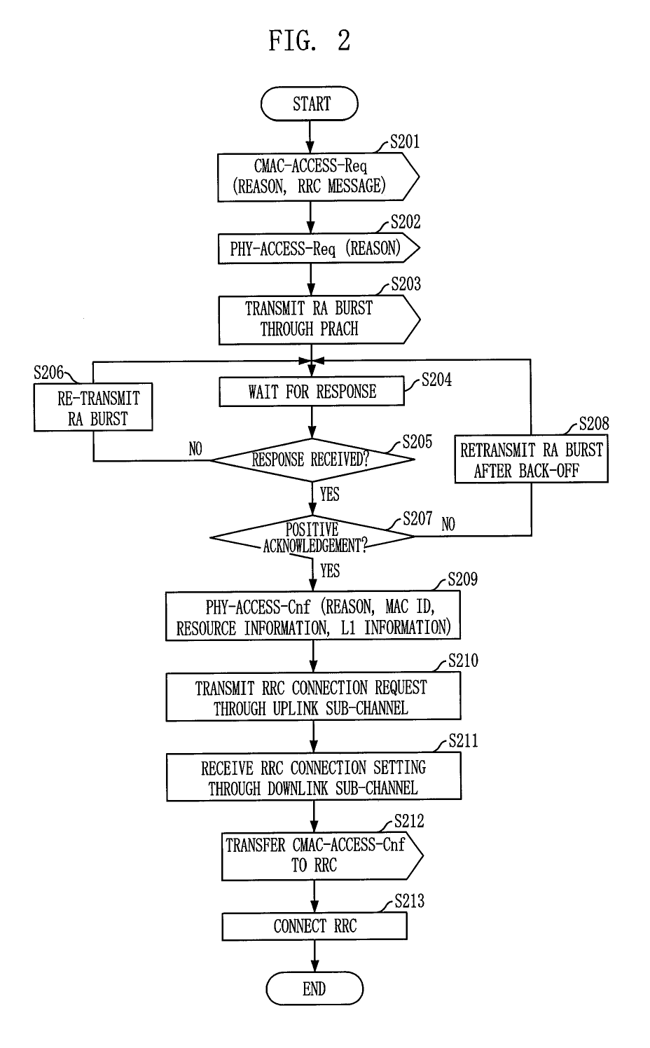

At first, the asynchronized random access, that is, the initial random access, will be described with reference to FIGS. 1 and 2.

FIG. 1 is a flowchart illustrating a method for processing initial asynchronized random access between a terminal and a base station in a cellular mobile communication system in accordance with an embodiment of the present invention.

A terminal 10 includes a protocol structure configured of a radio resource control (RRC) layer 11 as a third layer, a medium access control (MAC) layer 12 as a second layer, and a physical layer (PHY) 13 as a first layer. An Evolved Node B (eNB) 20 denotes a base station of the next generation mobile communication network. The eNB 20 includes a protocol structure configured of a radio resource control (RRC) layer 21 as a third layer, a medium access control (MAC) layer 22 as a second layer, and a physical layer (PHY) 23 as a first layer. Since a radio link layer (RLC) is not major interesting in the present invention, the detailed description thereof will be omitted.

A radio resource for an asynchronized random access in a uplink radio frame is located in a slot fixed in a radio frame, for example, the first slot or the last slot in a radio frame. A radio resource unit for the asynchronized random access is formed of MWRA denoting a sub carrier group size on a frequency domain and TRA denoting a symbol size on a time domain. The TRA may be allocated to one or a plurality of slots. Such a radio resource unit for an asynchronized random access is a random access (RA) burst, and the RA burst is a signature formed by two methods as follows.

At first, an RA burst is formed of only a preamble. Secondly, an RA burst is formed of a preamble and a payload. Herein, the preamble must have an auto-correlation characteristic and a cross-correlation characteristic. Also, the payload must be encoded with Cyclic Redundancy Check (CRC) to reliably transfer additional information for asynchronized random access, for example, the reason of asynchronous random access, to a base station or must be repeatedly encoded without CRC to obtain a coding gain.

Terminals randomly select an RA burst region in an uplink radio resource allocated by a base station for an asynchronized random access. Also, the terminals randomly select a signature for a preamble of an RA burst and transmits the selected RA burst region and the selected signature.

A base station may operate a signature pattern forming a preamble of an RA burst for an asynchronized random access by discriminating the signature pattern according to the reason of the asynchronized random access. That is, information such as the reason of the asynchronized random access can be expressed differently according to an RA burst forming method. At first, if the RA burst is formed of only a preamble, a base station puts information of differently dividing a signature pattern forming a preamble according to the random access reason into system information and transmits the system information. Accordingly, each of terminals transmits a different signature pattern according to an asynchronous random access reason using the asynchronous random access reason and signature pattern setup information in the system information transmitted from the base station. In this case, the signature pattern can be expressed as an index of a signature.

Secondly, the expression of information such as the reason of the asynchronized random access when the RA burst is formed of a preamble and a payload will be described. In order to transfer more information with minimum payload while an asynchronous random access is trying, the asynchronous random access reason can be discriminated by a signature pattern as described above. As another method, a signature pattern is randomly selected, and a payload can be transmitted by including the information such as the asynchronized random access reason in the payload.

The asynchronized random access reason may include initial access, handover, obtaining of uplink physical layer synchronization, transiting of a terminal state from an idle state to an active state, and updating of a tracking area (TA).

As shown in FIG. 1, a terminal requests to begin an initial access procedure by transmitting a CMAC-ACCESS-Req primitive, a random access request message, to the MAC layer 12 of the terminal at step S101 when an asynchronized random access is required due to such reasons. Although the RRC layer generally transmit a primitive and an RRC connection request message with the primitive and the RRC connection request message divided, the RRC layer may unify the primitive and the RRC connection request message into one message and transmit the unified message to the MAC layer. Therefore, the RRC control procedure can be simplified according to the present embodiment. The parameter of the CMAC-ACCESS-Req primitive includes the asynchronized random access reason and control information needed in a lower layer. Also, an RRC connection request message transferred to the MAC layer is temporally stored in the MAC layer. After a data channel to a base station is setup, the RRC connection request message is transmitted to the base station so as to perform an RRC connection procedure.

At step S102, the MAC layer 12 of the terminal performs a physical random access channel (PRACH) procedure by transferring a PHY-ACCESS-Req primitive to a physical layer (PHY) 13 of the terminal using the asynchronized random access reason and the control information included in the CMA-ACCESS-Req primitive. Herein, the MAC layer 12 puts the asynchronized random access reason into the PHY-ACCESS-Req primitive and transmits it to the physical layer.

The physical layer (PHY) 13 of the terminal performs the PRACH procedure according to the request of the MAC layer. That is, the physical layer 13 of the terminal forms an RA burst for the asynchronized random access request and transmits the RA burst to a physical layer 21 of the eNB through the PRACH at step S103.

As described above, the RA burst can be formed of only a preamble or a preamble and a payload. Herein, the asynchronized random access reason is included in the RA burst and transmitted to a base station. In case of the RA burst formed of the preamble only, the terminal sets up a signature pattern according to the asynchronized random access reason using the asynchronized random access reason and signature pattern setup information transmitted from the base station and transmits the signature pattern to the base station. Meanwhile, in case of the RA burst formed of the preamble and the payload, the asynchronized random access reason may be included in the payload.

When the physical layer 21 of the terminal receives the RA burst for the asynchronized random access from the terminal, the physical layer 21 requests a base station to perform a process related to a random access request by transmitting a PHY-ACCESS-Ind primitive to the MAC layer 22 of the base station at step S104. In other words, the physical layer 21 of the base station transfers a PHY-ACCESS-Ind primitive to the MAC layer 22. The PHY-ACCESS-Ind primitive includes information about a temporal terminal identifier ID allocated using the RA burst transmitted from the terminal to identify the terminal and the asynchronized random access reason included in the RA burst transmitted from the terminal. Herein, a signature index or a random identifier transmitted using the payload of the RA burst can be used as the temporal terminal ID.

The MAC layer 22 of the base station forms a response message according to the PHY-ACCESS-Ind primitive transferred from the physical layer 21 of the base station and returns a PHY-ACCESS-Rsp primitive to the physical layer 21 of the base station at steps S105 and S106. The MAC layer 22 of the base station transfers a temporal terminal identifier ID, a scheduling identifier MAC ID, uplink radio resource allocation information, and response information such as a positive acknowledgement ACK to the physical layer 21 of the base station.

The temporal terminal identifier ID is information about a terminal or a terminal group where a radio resource allocated for an asynchronized random access response belongs to. Accordingly, when a terminal receives the response message with a temporal identifier ID mapped to an RA burst transmitted by oneself, the terminal recognizes the received response message as own response information. For example, if a terminal using a signature index of 5 receives a temporal identifier of 5, the terminal recognizes the response message as own response information.

The scheduling identifier MAC ID is allocated by a scheduler of a base station when an asynchronized random access is tried by a terminal with no identifier to enable the scheduler to identify the terminal in a base station. The scheduling identifier is allocated because terminals in the idle state, which are trying the asynchronized random access in an idle state, have no identifier to be recognized by the scheduler of the base station within a cell. The allocated scheduling identifier is a terminal identifier also used to identify a radio resource by a physical layer.

The radio resource information denotes uplink data sub-channel information to be transmitted by a terminal in later. The radio resource information includes a radio resource location. The radio resource location is information for addressing uplink radio resource available to a terminal trying the asynchronized random access.

Meanwhile, the positive acknowledgment (ACK) can be omitted because the response message transmission may always denote the normal receipt of the RA burst message. The response information includes a positive acknowledgement (ACK) and a negative acknowledgement (NACK). A base station transmits a positive ACK value of 1 to terminals trying the asynchronized random access when the asynchronized random access successes. However, the base station transmits a negative ACK value of 0 to terminals trying the asynchronized random access when a payload of an asynchronized random access is unsuccessfully decoded although a preamble of an asynchronized random access is successfully decoded, when a received preamble signal is too high, or a radio resource to allocate is not proper.

If a terminal can learn a reason of trying an asynchronized random access through an RA burst transmitted from a terminal, a scheduler of a base station can variably allocate a size of uplink radio resource to be used by a terminal in future according to related situation.

When the physical layer 21 of the base station receives a PHY-ACCESS-Rsp primitive having a scheduling identifier MAC ID a temporal terminal identifier ID, and resource information from the MAC layer 22 of the base station, the physical layer 21 transfers a response message having a scheduling identifier MAC ID allocated from the MAC layer of the base station, a temporal terminal identifier, resource information, first layer information, and response information to the physical layer 13 of the terminal through an access grant channel at step S107.

The first layer information may include timing advanced information and power level information. The timing advanced information is timing information to adjust in order to enable a terminal to synchronize an uplink physical layer by reducing a timing error estimated by a base station using signature information transmitted when a terminal is trying the asynchronized random access. The power level information denotes power reference level information to setup a power level, which will be used when a terminal transmit data through a uplink, using a power level estimated by a base station using signature information transmitted when a terminal tries asynchronized random access.

When the physical layer 13 of the terminal receives a response message from the physical layer of the base station, the physical layer 13 transmits a PHY-ACCESS-Cnf primitive having a temporal identifier, a scheduling identifier MAC ID of a base station, resource information, and first layer information to the MAC layer 12 of a terminal at step S108.

When the MAC layer 12 of the terminal receives the PHY-ACCESS-Cnf primitive from the physical layer 13 of the terminal, the MAC layer 12 sets an uplink sub-channel using the resource information included in the PHY-ACCESS-Cnf primitive. The MAC layer 12 of the terminal communicates with the MAC layer 22 of the base station using the scheduling identifier MAC ID of the base station. In other words, after the MAC layer 12 of the terminal sets the uplink sub-channel using the information included in the PHY-ACCESS-Cnf primitive, the MAC layer 12 forms the temporally stored RRC connection request message as a MAC packet data unit (PDU) and transmits the MAC PDU to the MAC layer 22 of the base station at step S109.

When the MAC layer 22 of the base station receives a MAC PDU from the MAC layer 12 of the terminal, the MAC layer 22 analyses the received MAC PDU and transfers a CMAC-ACCESS-Ind primitive for requesting an RRC connection to the RRC layer 23 of the base station at step S110.

The RRC layer 23 of the base station performs a response procedure if the RRC layer 23 can directly perform the response procedure for the CMAC-ACCESS-Ind primitive. If the RRC layer 23 needs information about an upper node, the RRC layer 23 requests it to a gateway and receives a terminal unique identifier such as TMSI. In other words, if the received CMAC-ACCESS-Ind message includes a terminal identifier allocated by a base station, the RRC layer 23 can identify a corresponding terminal. Therefore, the RRC layer 23 performs the response procedure by displaying that the terminal is already registered at the base station. The RRC layer 23 of the base station transfers parameters and a response message for the RRC connection request to the MAC layer 22 of the base station using the CMAC-ACCESS-Rsp primitive at step S111.

Then, the MAC layer 22 of the base station receives the parameters and the RRC connection setup message from the RRC connection request from the RRC layer 23 of the base station, and transmits the RRC connection setup message to the MAC layer of the terminal through a downlink sub-channel at step s112. Herein, the MAC layer of the base station directly stores terminal identifier information such as C-RNTI among the received parameters and uses the stored terminal information for transmitting and receiving data to/from the terminal.

When the MAC layer 12 of the terminal receives the parameters and the RRC connection setup message from the MAC layer 22 of the base station, the MAC layer 12 of the terminal transfers the parameters and the RRC connection setup message to the RRC layer 11 of the terminal through the CMAC-ACCESS-Cnf primitive at step S113.

The RRC layer 11 of the terminal analyzes the RRC connection setup message using the CMAC-ACCESS-Cnf primitive from the MAC layer of the terminal, stores information required for RRC and performs related controlling operations of a lower layer. As a result, the RRC layer 11 of the terminal and the RRC layer 23 of the base station become an active state or a connection state.

FIG. 2 is a flowchart illustrating an asynchronized random access method in a terminal in accordance with an embodiment of the present invention.

The RRC layer 11 of the terminal requests the initial access procedure by transferring a CMAC-ACCESS-Req primitive, which is a random access request, to the MAC layer 12 of the terminal at step S201. Herein, the RRC layer of the terminal may be unify the CMAC-ACCESS-Req primitive and the RRC connection request message into one message and transmits the unified message to the MAC layer. The parameter of the CMAC-ACCESS-Req primitive includes the reason or the object of an asynchronized random access and control information needed at a lower layer.

The MAC layer 12 of the terminal temporally store the RRC connection request message and transmits the PHY-ACCESS-Req primitive to the physical layer 13 of the terminal using the asynchronized random access reason and the control information included in the CMAC-ACCESS-Req primitive to the physical layer 13 of the terminal to perform the PRACH procedure at step S202. Herein, the MAC layer 12 includes the asynchronized random access reason into the PHY-ACCESS-Req primitive and transfers the PHY-ACCESS-Req primitive to the physical layer.

The physical layer 13 of the terminal performs the PRACH procedure according to the request from the MAC layer of the terminal. That is, the physical layer 13 of the terminal forms an RA burst for the asynchronized random access request and transmits the RA burst to the physical layer 21 of the eNB through the PRACH at step S203.

Then, the physical layer of the terminal waits a response to receive according to the RA burst for the random access at step S204. The physical layer of the terminal transmits an RA burst without additional back-off at step S206 if the physical layer of the terminal did not receive a response for an RA burst from a base station for a predetermined slot of a frame at step S205. Therefore, the terminal can reduce unnecessary delay for call setup.

Meanwhile, a base station sets the ACK/NACK information in the response information to ‘NACK’ if an receiving end of a base station detects conflicts due to RA bursts transmitted from more than one of terminals in an RA burst region, that is, if a payload is not normally decoded although a signature is detected when an RA burst is formed of the signature and the payload, if interference increases because the receiving signal power of the preamble is too high, or if an available radio resource is not proper.

The terminal perform a back-off procedure when the response information transmitted from the base station is ‘NACK’, and retransmits an RA burst for asynchronized random access after a predetermined time is delayed at steps S207 and S208. Therefore, the asynchronized random access method according to the present embodiment reduces the probability of conflicts caused by RA bursts transmitted from terminals and enables terminals to try the asynchronized random access with a proper signal power.

When the response information received from the base station is the positive response at step S207, the physical layer 13 of the terminal puts the MAC identifier ID of the base station, resource information, and the first layer information, which are included in the response message transmitted from the physical layer of the base station, into the PHY-ACCESS-Cnf primitive, and transfers the PHY-ACCESS-Cnf primitive to the MAC layer of the terminal at step S209.

If the MAC layer 12 of the terminal receives the PHY-ACCESS-Cnf primitive from the physical layer 13 of the terminal, the MAC layer 12 of the terminal sets an uplink sub-channel using the resource information included in the PHY-ACCESS-Cnf primitive, forms the temporally stored RRC connection request message as a MAC packet data unit (PDU), and transmits the MAC PDU to the MAC layer 22 of the base station at step S210.

Then, if the MAC layer 12 of the terminal receives the parameter and the RRC connection setup message from the MAC layer 22 of the base station through the downlink sub-channel, the MAC layer 12 of the terminal transfers the parameters and the RRC connection setup message to the RRC layer 11 of the terminal through the CMAC-ACCESS-Cnf primitive at step S212.

The RRC layer 11 of the terminal analyzes the RRC connection setup message using the CMAC-ACCESS-Cnf primitive received from the MAC layer of the terminal, stores necessary information for RRC and performs a predetermined control operation of a lower layer at step S213. Therefore, the RRC layer of the base station and the RRC layer of the terminal become an active state or a connection state.

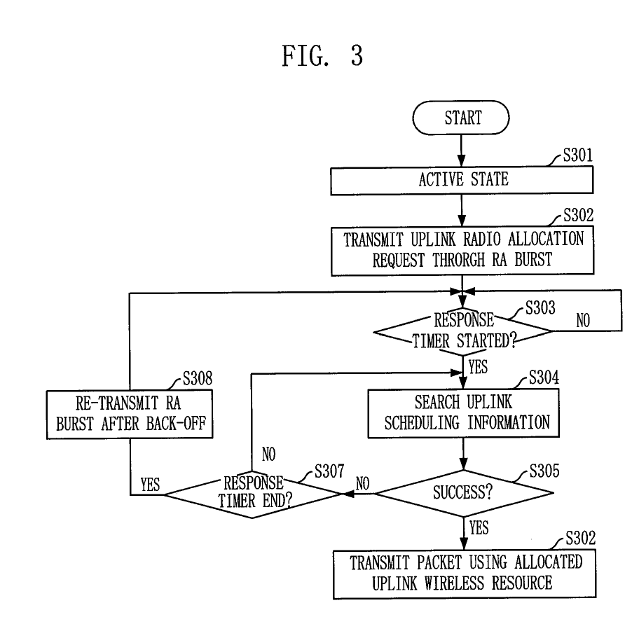

Meanwhile, a terminal may perform a synchronized random access procedure if uplink radio resources are not allocated to the terminal although the terminal has information to transmit to an uplink while the terminal is in an active state with the synchronization of the uplink physical layer to the base station sustained. FIG. 3 is a flowchart illustrating a synchronized random access method in accordance with an embodiment of the present invention.

A radio resource for random access within a radio frame of an uplink may be located in a slot within a radio frame. The same location of the asynchronized random access resource can be used, and additional resources can be allocated. An RA burst for the synchronized random access is formed of BWRA denoting a size of a sub carrier wave group on a frequency domain and TRA denoting a size of a symbol in a time domain like a unit of a radio resource for the asynchronized random access. The TRA can operate by allocating more than one slot through allocating one OFDMA symbol or a plurality of symbols. A minimum band (Synch BWRA) value of a sub carrier wave group for a synchronized random access can be applied differently from a minimum bandwidth (Non-synch BWRA) of a sub carrier wave group for an asynchronized random access.

Each of base stations transmits radio resource operation information in an uplink radio frame for a synchronized random access RA burst. The scheduler of the base station can allocate radio resources for an RA burst of a synchronized random access to each terminal or a terminal group and operates the radio resources through scheduling. Also, the scheduler enables each terminal in an active state to randomly select a synchronized random access RA burst.

If a terminal in an active state is not allocated with an uplink radio resource although the terminal has information to transmit to an uplink at step S301, the terminal selectively forms synchronized random access information such as uplink radio allocation request information using the synchronized random access RA burst at step S302. Herein, the uplink radio allocation information includes information about a scheduling identifier and a size of an uplink radio resource. Herein, the scheduling identifier is information about a terminal identifier to be uniquely recognized within a cell by a scheduler of a base station.

If a base station receives a synchronized random access RA burst from a terminal, the base station allocates a radio resource size which is information for addressing uplink radio resource to be used by a terminal trying synchronized random access and transmits the radio resource size information to a terminal through a downlink.

Herein, at step S304, a terminal trying synchronized random access checks uplink radio resources allocated to a corresponding terminal by searching uplink scheduling information transmitted to a downlink after a response timer starting time that is a predetermined synchronized random access response reference timer value. Herein, when the terminal dose not receive uplink scheduling information until the synchronized random access response end timer is expired at step S307, the terminal determines that the synchronized random access is failed and retransmits the synchronized random access RA bust at step S308. Herein, when the terminals randomly select and transmit an RA burst, the terminals perform a back-off procedure and retransmit the RA burst. Therefore, the probability of the synchronized random access RA burst conflict can be reduced.

Meanwhile, the terminal checks an uplink radio resource allocated to a corresponding terminal by searching uplink scheduling information transmitted through a downlink at step S305, and transmits a packet using the allocated uplink radio resource at step S306.

While the present invention has been described with respect to certain preferred embodiments, it will be apparent to those skilled in the art that various changes and modifications may be made without departing from the spirits and scope of the invention as defined in the following claims.

### INDUSTRIAL APPLICABILITY

The random access method according to the present invention can simplify RRC control operations of a terminal by unifying a procedure for forming and transmitting a CCCH message in RRC of a terminal and a procedure for forming and transfer a MAC control primitive into one procedure and performing the unified procedure in the asynchronized random access tried by a terminal to access a base station in a cellular system for providing a packet service.

Also, a base station receiving an RA burst allocates a scheduling identifier (MAC ID), a terminal unique identifier, in a MAC layer, not in an RRC layer, in the random access method according to the present invention. Therefore, time delay can be reduced. Furthermore, an RRC layer of a base station can directly identify a terminal identifier of an RRC message received through an uplink sub-channel and responses to the terminal signaling operation to a gateway can be reduced.

Moreover, since a synchronized random access is performed based on a timer in the present invention, a base station and a terminal can operation properly without additional control information according to whether a synchronized random access is successfully performed or not.

1. A method for processing random access to a base station in a terminal for random access between a terminal and a base station, comprising:
at an radio resource control (RRC) layer of the terminal, transferring a control primitive and an RRC connection request message to a medium access control (MAC) layer of the terminal;
at the MAC layer of the terminal, requesting the base station to allocate a resource for random access through a physical layer of the terminal;
at the MAC layer of the terminal, setting up an uplink sub-channel using the resource information allocated by the base station;
at the MAC layer of the terminal, transferring the RRC connection request message to the MAC layer of the base station through the uplink sub-channel; and
at the MAC layer of the terminal, receiving an RRC connection setup message from the MAC layer of the base station and transferring the RRC connection setup message to the RRC layer of the terminal.

2. A method for processing random access in a base station for random access between a terminal and a base station, comprising:
at a physical layer of the base station, transferring a random access order primitive to a medium access control (MAC) layer of the base station upon receipt of a random access request transmitted from the terminal through a random access channel;
at the MAC layer of the base station, allocating resources according to the random access order primitive;
at the MAC layer of the base station, transferring a response primitive including the allocated resource information and a scheduling identifier (MAC ID) of the base station to a physical layer of the base station;
at the MAC layer of the base station, transferring a radio resource connection (RRC) connection request to the RRC layer of the base station if the MAC layer of the base station receives an RRC connection request message from the terminal through an uplink sub-channel using the allocated resource;
at the radio resource control (RRC) layer of the base station, transferring an RRC connection setup message to a Medium Access Control (MAC) layer of the base station according to the RRC connection request; and
at the MAC layer of the base station, transferring the RRC connection setup message to the terminal through a downlink sub-channel.

3. A method for processing asynchronized random access in a terminal for random access between a terminal and a base station, comprising:
at a radio resource control (RRC) layer of the terminal, transferring a control primitive and an RRC connection request message to a Medium Access Control (MAC) layer of the terminal;
at the MAC layer of the terminal, requesting the base station to allocate resources for random access through a physical layer of the terminal;
retransmitting the resource allocation request without back-off if the physical layer of the terminal does not receive a response for the resource allocation request from the base station;
at the MAC layer of the terminal, setting up an uplink sub-channel using information about resources allocated by the base station if the MAC layer of the terminal receive the information about the resource allocated by the base station through the physical layer of the terminal;
at the MAC layer of the terminal, transferring the RRC connection request message to the MAC layer of the base station through the uplink sub-channel; and
at the MAC layer of the terminal, receiving an RRC connection setup message from the MAC layer of the base station and transferring the RRC connection setup message to the RRC layer of the terminal.

4. The method of claim 1, further comprising:
at the terminal, receiving signature pattern information according to a random access reason through system information broadcasted from the base station before transferring a control primitive and an RRC connection request message to a Medium Access Control (MAC) layer of the terminal at a radio resource control (RRC) layer of the terminal.

5. The method of claim 4, wherein the RRC layer of the terminal transfers a control primitive including a random access reason and an RRC connection request message to the MAC layer.

6. The method of claim 5, wherein the terminal selects a signature pattern according to the random access reason and transmits a resource allocation request including the random access reason to the base station.

7. The method of claim 5, wherein the MAC layer of the terminal temporally stores the RRC connection request message and transfers the random access reason to the physical layer of the terminal if the MAC layer of the terminal receives the random access reason and the RRC connection request message from the RRC layer.

8. The method of claim 3, wherein further comprising:
at the physical layer of the terminal, performing a back-off procedure and retransmitting the resource allocation request after the retransmitting, if the physical layer of the terminal receives a negative acknowledgement (NACK) for the resource allocation request from the base station; and
at the physical layer of the terminal, transferring allocated resource information to the MAC layer of the terminal if the physical layer of the terminal receives a positive acknowledgement for the resource allocation request from the base station.

9. The method of claim 2, further comprising: at the base station, transmitting signature pattern information according to a random access reason to the terminal through system information.

10. The method of claim 2, wherein the MAC layer of the base station allocates resources by selectively setting up uplink radio resource allocation information, response information, timing advanced information, and power level information.

11. The method of claim 9, wherein, the random access request transmitted from the terminal is a preamble including a signature pattern according to a random access reason.

12. The method of claim 11, wherein, response information is set as a positive acknowledgement (ACK) when the preamble is successfully received.

13. The method of claim 12, wherein the response information is set as a negative acknowledgement (NACK) if an uplink radio resource cannot be allocated although the preamble is successfully received.

14. The method of claim 13, wherein the response information is set as a negative acknowledgement (NACK) if conflict is detected because more than one terminal transmits preambles although the preamble is successfully received, if interference increases because the receiving signal power of the preamble is too high, or if available radio resources are improper.

15. A method for processing synchronized random access in a terminal for random access between a terminal and a base station, comprising:
at a terminal in an active state, transmitting an uplink radio allocation request to a base station;
at the terminal, searching uplink scheduling information transmitted through a downlink for a predetermined time;
at the terminal, retransmitting uplink radio allocation request for synchronized random access if the terminal does not receive the uplink scheduling information for the predetermined time; and
at the terminal, transmitting packet data using a radio resource allocated by confirming uplink radio resources allocated by the base station if the terminal searches the uplink scheduling information within the predetermined time.

16. The method of claim 3, further comprising:
at the terminal, receiving signature pattern information according to a random access reason through system information broadcasted from the base station before transferring a control primitive and an RRC connection request message to a Medium Access Control (MAC) layer of the terminal at a radio resource control (RRC) layer of the terminal.

17. The method of claim 9, wherein the MAC layer of the base station allocates resources by selectively setting up uplink radio resource allocation information, response information, timing advanced information, and power level information.
